(19) United States
(12) Patent Application Publication
(10) Pub. No.: US 2005/0282938 A1
(43) Pub. Date: Dec. 22, 2005

(54) Curable liquid resin composition

(75) Inventors: Hiroshi Yamaguchi, Tokyo (JP); Masanobu Sugimoto, Tsukuba Ibaraki (JP); Satoshi Kamo, Tokyo (JP); Zen Komiya, Tsukuba Ibaraki (JP)

Correspondence Address: NIXON & VANDERHYE, PC, 901 NORTH GLEBE ROAD, 11TH FLOOR, ARLINGTON, VA, 22203, US

(73) Assignees: DSM IP Assets B.V., TE Heeerlen (NL); Japan Synthetic Rubber Corporation, Tokyo (JP)

(21) Appl. No.: 11/079,480

(22) Filed: Mar. 15, 2005

(30) Foreign Application Priority Data
Mar. 15, 2004 (JP) 2004-072791
Mar. 7, 2005 (JP) 2005-59840

(51) Int. Cl. B05D 1/36

(52) U.S. Cl. 523/513

(57) ABSTRACT

The invention relates to a curable liquid resin composition which exhibits excellent curability, can be applied at high speed, and produces a cured product having a Young's modulus appropriate for the upjacket layer and excellent coating removal properties of the upjacket layer. The curable liquid resin composition according to the invention comprises: (A) a urethane (meth)acrylate, (B) a reactive diluent, (C) a polymerization initiator, and (D) particles with a number average particle size of 0.1-100 μm.

The present invention relates to a curable liquid resin upjacket composition which is applied to and cured on the surface of a resin-coated optical fiber. More particularly, the present invention relates to a curable liquid resin composition which excels in applicability and curability, produces a cured product exhibiting flame retardant properties, and is suitable as an optical fiber upjacket coating material excelling in upjacket layer peeling properties.

### BACKGROUND ART

In the production of an optical fiber, a glass fiber is produced by melting and spinning glass, and a resin coating is applied to the glass fiber for protection and reinforcement. An optical fiber coated with a resin is called a resin-coated optical fiber. This process is called fiber drawing. As the resin coating, a structure has been known in which a flexible primary coating layer is provided on the surface of the optical fiber and a rigid secondary coating layer is provided over the primary coating layer. A structure in which the optical fibers provided with the resin coatings are arranged side by side on a single plane and bundled using a bundling material, and a tape-shaped coating layer is further provided, has also been known for practical application. A resin composition for forming the primary coating layer is called a primary material, a resin composition for forming the secondary coating layer is called a secondary material, and a resin composition for forming the tape-shaped coating layer is called a ribbon matrix material.

The outer diameter of the resin-coated optical fiber is usually about 250 μm. In order to improve manual workability, the outer diameter is further increased to about 500 μm by applying another resin. Such a resin coating layer is usually called an upjacket layer. A resin-coated optical fiber including an upjacket layer is usually called an upjacketed optical fiber. Since the upjacket layer itself is not required to have optical properties, transparency is unnecessary for the upjacket layer. The upjacket layer may be colored to allow identification by naked eye observation. It is important for the upjacket layer be easily removed without causing damage to the primary coating layer and the secondary coating layer in the lower layers when connecting the resin-coated optical fibers (hereinafter called “coating removal properties”). Moreover, the upjacket layer is required to have flame retardant properties in the same manner as another coating layer in order to provide flame retardant properties to the optical fiber.

A curable resin used as the optical fiber coating material including a curable resin used for producing the upjacket layer is required to have superior applicability which allows high-speed fiber drawing and excellent liquid storage stability. After curing, the upjacket layer is required to have excellent coating removability in addition to characteristics such as sufficient strength and flexibility; excellent heat resistance; excellent weatherability; excellent resistance to acid and alkali; excellent oil resistance; low water absorption and hygroscopicity; and generation of hydrogen gas to only a small extent.

However, in a conventional upjacket material, since the upjacket layer strongly bonds to the ribbon matrix material layer in the upper layer or to the primary coating layer or the secondary coating layer in the lower layer, the upjacket layer may be damaged when exposing the resin-coated optical fiber by removing the ribbon matrix layer, or the primary coating layer or the secondary coating layer may be damaged when removing the upjacket layer from the resin-coated optical fiber. This decreases the connection workability of the optical fiber. Moreover, even if the removability with the adjacent layer are improved, an upjacket material further having flame retardant properties has been demanded.

As the material for the bundling material for the ribbon matrix material and the secondary coating layer of the optical fiber, an attempt has been made to incorporate organic or the inorganic particles into a coating resin material has been made to provide slip characteristics to the surface after curing and to provide antistatic performance. However, these compositions have problems relating to removability and flame retardant properties when used as the upjacket layer. Moreover, an optical fiber upjacket material exhibiting excellent removability and flame retardant properties has not been known.

Optical fiber coatings are known from for example Japanese Patent Application Laid-open No. 9-324136 and Japanese Patent Application Laid-open No. 2000-273127

### DISCLOSURE OF THE INVENTION

Problems to be Solved by the Invention

An object of the present invention is to provide a curable liquid resin composition which exhibits, after curing, excellent removability from an adjacent coating layer and flame retardant properties in combination, and is therefore suitable as an optical fiber upjacket material.

Another object of the present invention is to provide a curable liquid resin composition which exhibits excellent curability, can be applied at high speed, and produces a cured product having a Young's modulus appropriate for the upjacket layer and excellent coating removal properties of the upjacket layer.

Means for Solving the Problem

According to the present invention, the above object may be achieved by a curable liquid resin composition, comprising: (A) a urethane (meth)acrylate, (B) a reactive diluent, (C) a polymerization initiator, and (D) particles with a number average particle size of 0.1-100 μm.

Effect of the Invention

Since the curable liquid resin composition of the present invention can produce a cured product having a Young's modulus suitable for the upjacket layer and excellent coating removal properties of the upjacket layer, the curable liquid resin composition is suitable as an optical fiber upjacket material. Moreover, since the curable liquid resin composition of the present invention exhibits excellent removability from an adjacent coating layer and excellent flame retardant properties in combination, and exhibits excellent curability, the curable liquid resin composition is suitable for an optical fiber upjacket material which can be applied at high speed.

### BEST MODE FOR CARRYING OUT THE INVENTION

A urethane (meth)acrylate which is the component (A) of the present invention is produced by reacting a polyol, a polyisocyanate, and a hydroxyl group-containing (meth)acrylate. Specifically, the urethane (meth)acrylate is produced by reacting the isocyanate group of the polyisocyanate with the hydroxyl group of the polyol and the hydroxyl group of the hydroxyl group-containing (meth)acrylate.

As a method for reacting these compounds, a method of reacting the polyol, the polyisocyanate, and the hydroxyl group-containing (meth)acrylate all together; a method of reacting the polyol with the polyisocyanate, and reacting the resulting product with the hydroxyl group-containing (meth)acrylate; a method of reacting the polyisocyanate with the hydroxyl group-containing (meth)acrylate, and reacting the resulting product with the polyol; a method of reacting the polyisocyanate with the hydroxyl group-containing (meth)acrylate, reacting the resulting product with the polyol, and further reacting the resulting product with the hydroxyl group-containing (meth)acrylate; and the like can be given.

As examples of the polyol preferably used in this reaction, polyether polyol, polyester polyol, polycarbonate polyol, polycaprolactone polyol, and other polyols can be given. There are no specific limitations to the manner of polymerization of the structural units of these polyols, which may be any of random polymerization, block polymerization, or graft polymerization. As examples of the polyether polyol, polyethylene glycol, polypropylene glycol, polytetramethylene glycol, polyhexamethylene glycol, polyheptamethylene glycol, polydecamethylene glycol, aliphatic polyether polyols obtained by the ring-opening copolymerization of two or more ion-polymerizable cyclic compounds, and the like can be given. As examples of the ion-polymerizable cyclic compounds, cyclic ethers such as ethylene oxide, propylene oxide, butene-1-oxide, isobutene oxide, 3,3-bischloromethyloxetane, tetrahydrofuran, 2-methyltetrahydrofuran, 3-methyltetrahydrofuran, dioxane, trioxane, tetraoxane, cyclohexene oxide, styrene oxide, epichlorohydrin, glycidyl methacrylate, allyl glycidyl ether, allyl glycidyl carbonate, butadiene monoxide, isoprene monoxide, vinyl oxetane, vinyl tetrahydrofuran, vinyl cyclohexene oxide, phenyl glycidyl ether, butyl glycidyl ether, and glycidyl benzoate can be given. A polyether polyol obtained by the ring-opening copolymerization of the ion-polymerizable cyclic compound with a cyclic imine such as ethyleneimine, a cyclic lactonic acid such as β-propyolactone or lactide glycolate, or a dimethylcyclopolysiloxane may also be used. As examples of specific combinations of two or more ion-polymerizable cyclic compounds, combinations of tetrahydrofuran and propylene oxide, tetrahydrofuran and 2-methyltetrahydrofuran, tetrahydrofuran and 3-methyltetrahydrofuran, tetrahydrofuran and ethylene oxide, propylene oxide and ethylene oxide, butene-1-oxide and ethylene oxide, a ternary copolymer of tetrahydrofuran, butene-1-oxide, and ethylene oxide, and the like can be given. The ring-opening copolymer of these ion-polymerizable cyclic compounds may be either a random copolymer or a block copolymer.

Examples of commercially available products of these aliphatic polyether polyols include PTMG650, PTMG1000, PTMG2000 (manufactured by Mitsubishi Chemical Corp.), PPG400, PPG1000, PPG2000, PPG3000, Excenol 720, 1020, 2020 (manufactured by Asahi Glass Urethane Co., Ltd.), PEG1000, Unisafe DC1100, DC1800 (manufactured by Nippon Oil and Fats Co., Ltd.), PPTG2000, PPTG1000, PTG400, PTGL2000 (manufactured by Hodogaya Chemical Co., Ltd.), Z-3001-4, Z-3001-5, PBG2000A, PBG2000B, (manufactured by Daiichi Kogyo Seiyaku Co., Ltd.), and the like.

Examples of the polyether polyols include cyclic polyether polyols such as alkylene oxide addition polyol of bisphenol A, alkylene oxide addition polyol of bisphenol F, hydrogenated bisphenol A, hydrogenated bisphenol F, alkylene oxide addition polyol of hydrogenated bisphenol A, alkylene oxide addition polyol of hydrogenated bisphenol F, alkylene oxide addition polyol of hydroquinone, alkylene oxide addition polyol of naphthohydroquinone, alkylene oxide addition polyol of anthrahydroquinone, 1,4-cyclohexane polyol, and its alkylene oxide addition polyol, tricyclodecane polyol, tricyclodecanedimethanol, pentacyclopentadecane polyol, pentacyclopentadecanedimethanol, and the like. Of these, alkylene oxide addition polyol of bisphenol A and tricyclodecanedimethanol are preferable. These polyols are commercially available as Uniol DA400, DA700, DA1000, DB400 (manufactured by Nippon Oil and Fats Co., Ltd.), tricyclodecanedimethanol (manufactured by Mitsubishi Chemical Corp.), and the like. Examples of cyclic polyether polyols include alkylene oxide addition polyol, alkylene oxide addition polyol of bisphenol F, alkylene oxide addition polyol of 1,4-cyclohexane polyol, and the like.

As examples of the polyester polyols, polyester polyols obtained by reacting a dihydric alcohol and a dibasic acid, and the like can be given. Examples of the dihydric alcohol include ethylene glycol, polyethylene glycol, propylene glycol, polypropylene glycol, tetramethylene glycol, polytetramethylene glycol, 1,6-hexane polyol, neopentyl glycol, 1,4-cyclohexanedimethanol, 3-methyl-1,5-pentane polyol, 1,9-nonane polyol, 2-methyl-1,8-octane polyol, and the like. Examples of the dibasic acid include phthalic acid, isophthalic acid, terephthalic acid, maleic acid, fumaric acid, adipic acid, sebacic acid, and the like. These polyester polyols are commercially available as Kurapol P-2010, PMIPA, PKA-A, PKA-A2, PNA-2000 (manufactured by Kuraray Co., Ltd.), and the like.

As examples of the polycarbonate polyol, polycarbonate of polytetrahydrofuran and polycarbonate of 1,6-hexanepolyol can be given. As commercially available products of the polycarbonate polyol, DN-980, 981, 982, 983 (manufactured by Nippon Polyurethane Industry Co., Ltd.), PC-8000 (manufactured by PPG), PC-THF-CD (manufactured by BASF), and the like can be given.

As examples of the polycaprolactone polyol, polycaprolactone polyols obtained by reacting ε-caprolactone with a polyol such as ethylene glycol, polyethylene glycol, propylene glycol, polypropylene glycol, tetramethylene glycol, polytetramethylene glycol, 1,2-polybutylene glycol, 1,6-hexane polyol, neopentyl glycol, 1,4-cyclohexanedimethanol, or 1,4-butane polyol, and the like can be given. These polyols are commercially available as Placcel 205, 205AL, 212, 212AL, 220, 220AL (manufactured by Daicel Chemical Industries, Ltd.), and the like.

Polyols other than those mentioned above may also be used. Examples of such other polyols include ethylene glycol, propylene glycol, 1,4-butanepolyol, 1,5-pentane polyol, 1,6-hexane polyol, neopentyl glycol, 1,4-cyclohexanedimethanol, dimethylol compound of dicyclopentadiene, tricyclodecanedimethanol, b-methyl-d-valerolactone, hydroxy terminated polybutadiene, hydroxy terminated hydrogenated polybutadiene, castor oil modified polyol, polyol terminated compound of polydimethylsiloxane, polydimethylsiloxane carbitol modified polyol, and the like.

A diamine may be used in combination with the polyol. As examples of such a diamine, ethylenediamine, tetramethylenediamine, hexamethylenediamine, p-phenylenediamine, 4,4′-diaminodiphenylmethane, diamine containing a hetero atom, polyether diamine, and the like can be given.

Of these polyols, the polyether polyol is preferable, with the aliphatic polyether polyol being particularly preferable. Specifically, polypropylene glycol and a copolymer of butene-1-oxide and ethylene oxide are preferable. These polyols are commercially available as PPG400, PPG1000, PPG2000, PPG3000, Excenol 720, 1020, 2020 (manufactured by Asahi Glass Urethane Co., Ltd.), and the like. A diol which is the copolymer of butene-1-oxide and ethylene oxide is commercially available as EO/BO500, EO/BO1000, EO/BO2000, EO/BO3000, EO/BO4000 (manufactured by Daiichi Kogyo Seiyaku Co., Ltd.), and the like.

As examples of the polyisocyanate, 2,4-tolylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, 1,6-hexane diisocyanate, isophorone diisocyanate, methylenebis(4-cyclohexylisocyanate), 2,2,4-trimethylhexamethylene diisocyanate, bis(2-isocyanate ethyl)fumarate, 6-isopropyl-1,3-phenyl diisocyanate, 4-diphenylpropane diisocyanate, lysine diisocyanate, hydrogenated diphenylmethane diisocyanate, hydrogenated xylylene diisocyanate, tetramethylxylylene diisocyanate, 2,5(or 2,6)-bis(isocyanatemethyl)-bicyclo[2.2.1]heptane, and the like can be given. Of these, 2,4-tolylene diisocyanate, isophorone diisocyanate, xylylene diisocyanate, methylenebis(4-cyclohexylisocyanate), and the like are preferable.

These polyisocyanates may be used either individually or in combination of two or more.

Examples of (meth)acrylates containing a hydroxyl group include 2-hydroxyethyl (meth)acrylate, 2-hydroxypropyl (meth)acrylate, 2-hydroxybutyl (meth)acrylate, 2-hydroxy-3-phenyloxypropyl (meth)acrylate, 1,4-butane polyol mono(meth)acrylate, 2-hydroxyalkyl(meth)acryloyl phosphate, 4-hydroxycyclohexyl (meth)acrylate, 1,6-hexanepolyol mono(meth)acrylate, neopentyl glycol mono(meth)acrylate, trimethylolpropane di(meth)acrylate, trimethylolethane di(meth)acrylate, pentaerythritol tri(meth)acrylate, dipentaerythritol penta(meth)acrylate, and (meth)acrylates shown by the following formulas (1) and (2). 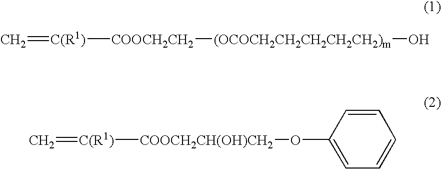
wherein R¹ represents a hydrogen atom or a methyl group, and m is an integer of 1-15.

A compound obtained by the addition-reaction of a glycidyl group-containing compound such as alkyl glycidyl ether, allyl glycidyl ether, or glycidyl (meth)acrylate with (meth)acrylic acid may also be used. Of these hydroxyl group-containing (meth)acrylates, 2-hydroxyethyl (meth)acrylate and 2-hydroxypropyl (meth)acrylate are preferable.

These hydroxyl group-containing (meth)acrylates may be used either individually or in combination of two or more.

The proportion of the polyol, polyisocyanate, and (meth)acrylate containing a hydroxyl group is preferably determined so that isocyanate groups included in the polyisocyanate and hydroxyl groups included in the (meth)acrylate containing a hydroxyl group are respectively 1.1-3 equivalents and 0.2-1.5 equivalents for one equivalent of hydroxyl groups included in the polyol.

In the reaction of these compounds, it is preferable to use a urethanization catalyst, such as copper naphthenate, cobalt naphthenate, zinc naphthenate, dibutyl tin dilaurate, triethylamine, 1,4-diazabicyclo[2.2.2]octane, or 2,6,7-trimethyl-1,4-diazabicyclo[2.2.2]octane, in an amount of 0.01-1 part by weight for 100 parts by weight of the total amount of the reactants. The reaction temperature is preferably 10-90° C., and particularly preferably 30-80° C.

A part of the hydroxyl group-containing (meth)acrylate may be replaced by a compound having a functional group which can be added to an isocyanate group. For example, γ-mercaptotrimethoxysilane, γ-aminotrimethoxysilane, and the like can be given. Use of these compounds improves adhesion to substrates such as a secondary coating layer.

A urethane (meth)acrylate which is the reaction product of the polyisocyanate and the hydroxyl group-containing (meth)acrylate compound may be included in the curable liquid resin composition of the present invention. Examples of such a urethane (meth)acrylate include a urethane (meth)acrylate obtained by reacting two mol of the hydroxyl group-containing (meth)acrylate compound with one mol of the diisocyanate, such as a reaction product of hydroxyethyl (meth)acrylate and 2,4-tolylene diisocyanate, reaction product of hydroxyethyl (meth)acrylate and 2,5 (or 2,6)-bis(isocyanatemethyl)-bicyclo[2.2.1]heptane, reaction product of hydroxyethyl (meth)acrylate and isophorone diisocyanate, reaction product of hydroxypropyl (meth)acrylate and 2,4-tolylene diisocyanate, and reaction product of hydroxypropyl (meth)acrylate and isophorone diisocyanate. The urethane (meth)acrylate which is the reaction product of the polyisocyanate and the hydroxyl group-containing (meth)acrylate compound may be separately prepared from the urethane (meth)acrylate which is the reaction product of the polyol, the polyisocyanate, and the hydroxyl group-containing (meth)acrylate compound, and incorporated into the composition of the present invention, or the urethane (meth)acrylate which is the reaction product of the polyisocyanate and the hydroxyl group-containing (meth)acrylate compound and the urethane (meth)acrylate which is the reaction product of the polyol, the polyisocyanate, and the hydroxyl group-containing (meth)acrylate compound may be prepared by adjusting the molar ratio of the polyol, the polyisocyanate, and the hydroxyl group-containing (meth)acrylate when synthesizing the polyol, the polyisocyanate, and the hydroxyl group-containing (meth)acrylate.

The urethane (meth)acrylate formed using the polyol is incorporated into the resin composition in an amount of usually 30-90 mass % for the total amount of the composition excluding the particles (D) and the flame retardant (E) (hereinafter called “resin component total amount”). The amount is preferably 55-87 mass %, and particularly preferably 65-85 mass %. If the amount is less than 30 mass %, the temperature dependence of the modulus of elasticity is great. If the amount is more than 90 mass %, the curable liquid resin composition may have a high viscosity.

A reactive diluent which is the component (B) is a compound including an ethylenically unsaturated group other than the component (A). As the component (B), a polymerizable monofunctional compound or a polymerizable polyfunctional compound may be used. Examples of the monofunctional compound include lactams containing a vinyl group such as N-vinylpyrrolidone and N-vinylcaprolactam, (meth)acrylates containing an alicyclic structure such as isobornyl (meth)acrylate, bornyl (meth)acrylate, tricyclodecanyl (meth)acrylate, and dicyclopentanyl (meth)acrylate, benzyl (meth)acrylate, 4-butylcyclohexyl (meth)acrylate, acryloylmorpholine, vinyl imidazole, vinylpyridine, and the like. Further examples include 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, isostearyl (meth)acrylate, tetrahydrofurfuryl (meth)acrylate, butoxyethyl (meth)acrylate, ethoxydiethylene glycol (meth)acrylate, benzyl (meth)acrylate, phenoxyethyl (meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypolypropylene glycol (meth)acrylate, diacetone (meth)acrylamide, isobutoxymethyl (meth)acrylamide, N,N-dimethyl (meth)acrylamide, t-octyl (meth)acrylamide, dimethylaminoethyl (meth)acrylate, diethylaminoethyl (meth)acrylate, 7-amino-3,7-dimethyloctyl (meth)acrylate, N,N-diethyl(meth)acrylamide, N,N-dimethylaminopropyl(meth)acrylamide, hydroxybutyl vinyl ether, lauryl vinyl ether, cetyl vinyl ether, 2-ethylhexyl vinyl ether, and compounds shown by the following formulas (3) to (6). 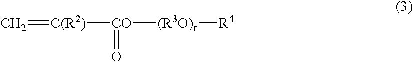
wherein R² represents a hydrogen atom or a methyl group, R³ represents an alkylene group having 2-6, and preferably 2-4 carbon atoms, R⁴ represents a hydrogen atom or an alkyl group having 1-12, and preferably 1-9 carbon atoms, and r is an integer of 0-12, and preferably 1-8. 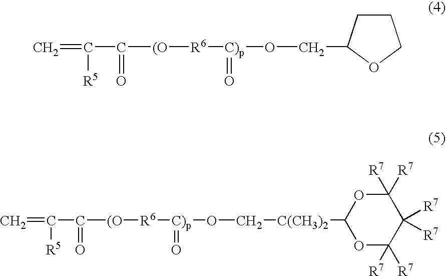
wherein R⁵ represents a hydrogen atom or a methyl group, R⁶ represents an alkylene group having 2-8, and preferably 2-5 carbon atoms, R⁷ represents a hydrogen atom or a methyl group, and p is an integer of preferably 1-4. 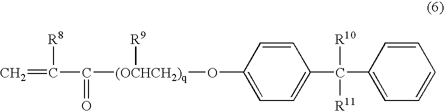
wherein R⁸, R⁹, R¹⁰, and R¹¹ individually represent a hydrogen atom or a methyl group, and q is an integer of 1-5.

Of these polymerizable monofunctional compounds, lactams containing a vinyl group such as N-vinylpyrrolidone and N-vinylcaprolactam, isobornyl (meth)acrylate, lauryl (meth)acrylate, and 2-ethylhexyl (meth)acrylate are preferable.

As commercially available products of these polymerizable monofunctional compounds, IBXA (manufactured by Osaka Organic Chemical Industry Co., Ltd.), Aronix M-111, M-113, M-114, M-117, and TO-1210 (manufactured by Toagosei Co., Ltd.) may be used.

Examples of the polymerizable polyfunctional compounds include trimethylolpropane tri(meth)acrylate, trimethylolpropanetrioxyethyl (meth)acrylate, pentaerythritol tri(meth)acrylate, triethylene glycol diacrylate, tetraethylene glycol di(meth)acrylate, tricyclodecanediyldimethylene di(meth)acrylate, 1,4-butanepolyol di(meth)acrylate, 1,6-hexanepolyol di(meth)acrylate, neopentyl glycol di(meth)acrylate, tripropylene glycol di(meth)acrylate, neopentyl glycol di(meth)acrylate, (meth)acrylic acid-terminated bisphenol A diglycidyl ether, pentaerythritol tri(meth)acrylate, pentaerythritol tetra(meth)acrylate, polyester di(meth)acrylate, tris(2-hydroxyethyl)isocyanurate tri(meth)acrylate, tris(2-hydroxyethyl)isocyanurate di(meth)acrylate, tricyclodecanedimethanol di(meth)acrylate, di(meth)acrylate of ethylene oxide or propylene oxide addition polyol of bisphenol A, di(meth)acrylate of ethylene oxide or propylene oxide addition polyol of hydrogenated bisphenol A, epoxy (meth)acrylate prepared by the addition of (meth)acrylate to diglycidyl ether of bisphenol A, triethylene glycol divinyl ether, compounds shown by the following formula (7), and the like.
CH₂═C(R¹²)—COO—(CH₂—CH(R¹³)—O)ₙ—CO—C(R¹²)═CH₂ (7)
wherein R¹² and R¹³ individually represent a hydrogen atom or a methyl group, and n is an integer of 1-100.

Of these polymerizable polyfunctional compounds, the compound shown by the above formula (7) such as ethylene glycol di(meth)acrylate, polyethylene glycol di(meth)acrylate, tricyclodecanediyldimethylene di(meth)acrylate, di(meth)acrylate of ethylene oxide addition bisphenol A, tris(2-hydroxyethyl)isocyanurate tri(meth)acrylate, and tripropylene glycol di(meth)acrylate are preferable.

As commercially available products of these polymerizable polyfunctional compounds, Yupimer UV, SA1002 (manufactured by Mitsubishi Chemical Corp.), Aronix M-215, M-315, and M-325 (manufactured by Toagosei Co., Ltd.) can be given.

Aronix TO-1210 (manufactured by Toagosei Co., Ltd.) may also be used.

The reactive diluent (B) is incorporated in an amount of usually 1-70 mass % for the total amount of the resin components. The amount is preferably 5-50 mass %, and particularly preferably 10-40 mass %. If the amount is less than 1 mass %, the curability may be hindered. If the amount exceeds 70 mass %, a change in the application form may occur due to a decrease in viscosity, whereby application becomes unstable.

The curable liquid resin composition of the present invention includes a polymerization initiator as the component (C). As the polymerization initiator, a heat polymerization initiator or a photoinitiator may be used.

When the curable liquid resin composition of the present invention is cured by application of heat, a heat polymerization initiator such as a peroxide or an azo compound is used. As specific examples of the heat polymerization initiator, benzoyl peroxide, t-butyloxybenzoate, azobisisobutyronitrile, and the like can be given.

When the curable liquid resin composition of the present invention is cured by application of light, a photoinitiator is used. It is preferable to use a photosensitizer in combination, as required. Examples of the photopolymerization initiator include 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyl diphenylphosphine oxide, bis-(2,6-dimethoxybenzoyl)-2,4,4-trimethylpentylphosphine oxide; Irgacure 184, 369, 651, 500, 907, CGI 1700, CGI 1750, CGI 1850, CG24-61, Darocur 1116, 1173 (manufactured by Ciba Specialty Chemicals Co.); Lucirin TPO (manufactured by BASF); Ubecryl P36 (manufactured by UCB), and the like. As examples of the photosensitizer, triethylamine, diethylamine, N-methyldiethanoleamine, ethanolamine, 4-dimethylaminobenzoic acid, methyl 4-dimethylaminobenzoate, ethyl 4-dimethylaminobenzoate, isoamyl 4-dimethylaminobenzoate; Ubecryl P102, 103, 104, 105 (manufactured by UCB); and the like can be given.

If heat and ultraviolet light are used to cure the curable liquid resin composition of the present invention, a heat polymerization initiator and photoinitiator may be used in combination. The polymerization initiator (C) is used in an amount of preferably 0.1-10 mass %, and particularly preferably 0.3-7 mass % for the total amount of the resin components.

The curable liquid resin composition of the present invention includes particles with a number average particle size of 0.1-100 μm as the component (D). As examples of the particles as the component (D), inorganic particles and organic polymer particles can be given.

As the inorganic particles, an inorganic hydroxide such as aluminum hydroxide and magnesium hydroxide, an inorganic oxide such as antimony trioxide, antimony pentaoxide, and guanidine nitride, and the like be given. However, particles including silica as the major component are excluded. Of these, an inorganic hydroxide such as aluminum hydroxide and magnesium hydroxide has properties as a flame retardant, flame retardant properties can be provided to the curable liquid resin composition of the present invention. As commercially available products of these inorganic particles, C302A (aluminum hydroxide, particle size: 1.14 μm, 2.0 μm, and 5.0 □m, manufactured by Sumitomo Chemical Industries Co., Ltd.), H42-S (stearic acid-surface-treated aluminum hydroxide: manufactured by Showa Denko K.K.), H42-STV (vinylsilane-surface-treated aluminum hydroxide: manufactured by Showa Denko K.K.), UD-650 (magnesium hydroxide; particle size: 3.26 μm; and manufactured by Ube Material Industries, Ltd.), UD-653 (magnesium hydroxide; particle size: 3.02 □m), fatty acid-surface-treated magnesium hydroxide (manufactured by Kyowa Hakko Kogyo Co., Ltd.; particle size: 1.0 μm), 200-06H, Kisuma 5Q (manufactured by Kyowa Chemical Industry Co., Ltd.), flame retardant aluminum hydroxide, aluminum oxide trihydrate, alminium trihydroxide (manufactured by Sumitomo Chemical Industries Co., Ltd.), and the like can be given. Surface-hydrophobized aluminum hydroxide and magnesium particles may be used to improve the mutual solubility with the resin. As examples of vinylsilane-treated magnesium hydroxide, Kisuma-5L and Kisuma-5P can be given. As examples of surface-fatty acid-treated magnesium hydroxide, Kisuma-5A and Kisuma-5B (manufactured by Kyowa Chemical Industry Co., Ltd.) can be given. As hydrophobized products of aluminum hydroxide, H42-STV and H42-S (manufactured by Showa Denko K.K.) can be given. As a result of examination of water absorption for using these inorganic particles, a surface-treated particle is effective in water absorption and exhibits only a small amount of transmission loss.

As examples of the organic polymer particles, a polyolefin, an acrylic resin, a polyurethane, a polyamide, a polystyrene, a silicone resin, a styrene/divinylbenzene copolymer, and the like can be given. As the polymer particles, either crosslinked polymer particles or uncrosslinked polymer particles may be used. Of these, the acrylic resin particles such as polymethyl methacrylate are particularly preferable, since the acrylic resin particles exhibit excellent weatherability due to the absence of an unsaturated bond in the polymer main chain. Moreover, since many crosslinkable monomers can be easily copolymerized at an arbitrary ratio, the polymer particles can be highly crosslinked. As commercially available products of the organic polymer particles, Mipelon XM-220 (manufactured by Mitsui Petrochemical Co., Ltd.), polymethyl methacrylate spherical fine particle MB, MBX, polystyrene particle SBX (manufactured by Sekisui Plastics Co., Ltd.), silicone high performance powder Torayfill (manufactured by Toray-Dow Corning Silicone Co., Ltd.), spherical functional fine particle polymer Art Pearl (manufactured by Negami Chemical industrial Co., Ltd.), and the like can be given.

The number average particle size of the component (D) measured by a dynamic light scattering method or electron microscopy is preferably 0.1-100 μm, still more preferably 0.5-100 μm, and particularly 0.5-10 μm. If the number average particle size is less than 0.1 μm, the removability of the upjacket layer is decreased. If the number average particle size exceeds 100 μm, problems occur relating to filtration and durability.

The component (D) is incorporated in an amount of preferably 1-120 parts by mass for 100 parts by mass of the total amount of the resin components. If the amount is less than 1 part by mass, the removability of the upjacket layer are insufficient. If the amount exceeds 120 parts by mass, the curing speed upon UV irradiation and durability are decreased.

The flame retardant (E) may be added to the curable liquid resin composition of the present invention. In the curable composition of the present invention, the flame retardant (E) is added to provide flame retardant properties to the cured product of the composition and to improve coating removal properties. There are no specific limitations to the flame retardant (E). However, compounds corresponding to the component (D) are excluded, and a compound which does not exhibit reactivity with the resin component is preferable. As examples of the flame retardant (E), halogen-type (bromine or chlorine), phosphorus-type, nitrogen-type, and silicone-type flame retardants can be given.

As examples of the bromine-type flame retardant, tetrabromo bisphenol A (TBBPA), decabromodiphenyl oxide, hexabromocyclododecane, tribromophenol, ethylenebistetrabromophthalimide, TBBPA polycarbonate oligomer, brominated polystyrene, TBBPA epoxy oligomer, TBBPA bisbromopropyl ether, ethylenebispentabromodiphenol, hexabromobenzene, brominated aromatic triazine, and the like can be given.

As examples of the phosphorus-type flame retardant, a phosphate, halogen-containing phosphate, ammonium polyphosphate, red phosphorus-type flame retardant, phosphaphenanthrene-type flame retardant, and the like can be given. Of these, tri(isopropylphenyl)phosphate is preferable.

As examples of the chlorine-type flame retardant, chlorinated paraffin, perchlorocyclopentadecane, chlorendic acid, and the like can be given.

The flame retardant (E) is incorporated in an amount of preferably 1.0-100 parts by mass, still more preferably 1.0-76 parts by mass, and particularly preferably 1.0-50 parts by mass for 100 parts by mass of the total amount of the resin components. If the amount is less than 1.0 part by mass, the flame retardant effect is insufficient. If the amount exceeds 100 parts by mass, the flame retardant may bleed out from the cured product, or the elastic properties as an upjacket layer and the like may be adversely affected.

Various additives such as antioxidants, coloring agents, UV absorbers, light stabilizers, silane coupling agents, heat polymerization inhibitors, leveling agents, surfactants, preservatives, plasticizers, lubricants, solvents, fillers, aging preventives, wettability improvers, and coating surface improvers may be optionally added to the curable liquid resin composition of the present invention, insofar as the characteristics of the composition are not adversely affected.

The curable liquid resin composition of the present invention is cured using heat or radiation. Radiation used herein includes infrared light, visible light, ultraviolet light, X-rays, electron beams, α-rays, β-rays, γ-rays, and the like. In the case of curing the curable liquid resin composition of the present invention using electron beams, the curable liquid resin composition may not include the photoinitiator as the component (C).

The optical fiber upjacket layer of the present invention is obtained by applying the liquid curable composition to a resin-coated optical fiber, and curing the applied composition under the above curing conditions. The optical fiber upjacket layer of the present invention has a Young's modulus of preferably 80-400 MPa, and still more preferably 100-300 MPa. The optical fiber upjacket layer of the present invention exhibits excellent coating removal properties. In more detail, in the case of providing an optical fiber upjacket layer to a resin-coated optical fiber with an outer diameter of 250 μm to form an upjacketed optical fiber upjacket with an outer diameter of 500 μm, it is preferable that the coating removal stress measured by a method described later be less than 3N. It is preferable that the optical fiber upjacket layer of the present invention have a Young's modulus and coating removal stress within the preferable range.

The upjacketed optical fiber of the present invention is a resin-coated optical fiber including the above optical fiber upjacket layer. The upjacketed optical fiber usually has a resin-coated optical fiber with an outer diameter of 250 μm. The outer diameter of the upjacketed optical fiber is 500-1000 μm.

### EXAMPLES

The present invention is described below in detail by way of examples. However, the following examples should not be construed as limiting the present invention.

### Preparation Example 1

### Synthesis of Urethane (meth)acrylate (A)

A reaction vessel equipped with a stirrer was charged with 209.27 g of tripropylene glycol diacrylate, 0.31 g of 2,6-di-t-butyl-p-cresol, 35.32 g of toluene diisocyanate, and 71.11 g of polypropylene glycol with a number average molecular weight of 700. The mixture was then cooled to 15° C. After the addition of 0.104 g of dibutyltin dilaurate, the mixture was stirred for one hour while controlling the liquid temperature at less than 40° C. The mixture was then cooled with ice to 10° C. or less with stirring. After the dropwise addition of 23.55 g of hydroxyethyl acrylate while controlling the liquid temperature at 20° C. or less, the mixture was allowed to react for one hour with stirring. The mixture was further stirred at 70-75° C. for three hours. The reaction was terminated when the residual isocyanate content decreased to 0.1 mass % or less. The resulting urethane (meth)acrylate (A) is referred to as “UA-1”.

### Preparation Example 2

### Synthesis of Urethane (meth)acrylate (A)

A reaction vessel equipped with a stirrer was charged with 203.25 g of 2-ethylhexyl acrylate, 0.146 g of 2,6-di-t-butyl-p-cresol, 191.87 g of toluene diisocyanate, and 205.90 g of polypropylene glycol with a number average molecular weight of 1000. The mixture was then cooled to 15° C. After the addition of 0.488 g of dibutyltin dilaurate, the mixture was stirred for one hour while controlling the liquid temperature at less than 40° C. The mixture was then cooled with ice to 10° C. or less with stirring. Then, 37.73 g of hydroxypropyl acrylate was slowly added dropwise while controlling the liquid temperature at 20° C. or less. After the dropwise addition of 174.42 g of hydroxyethyl acrylate while controlling the liquid temperature at 20° C. or less, the mixture was allowed to react for one hour with stirring. The mixture was further stirred at 70-75° C. for three hours. The reaction was terminated when the residual isocyanate content decreased to 0.1 mass % or less. As a result, a mixed solution of three types of urethane (meth)acrylate oligomer (A) consisting of an urethane acrylate oligomer in which hydroxyethyl acrylate was bonded to each terminal hydroxyl group of polyethylene glycol bisphenol A ether through toluene diisocyanate (“UA-2”), an urethane acrylate oligomer in which hydroxyethyl acrylate was bonded to each terminal hydroxyl group of polytetramethylene glycol through toluene diisocyanate (“UA-3”), and an urethane acrylate oligomer in which hydroxyethyl acrylate was bonded to two isocyanate groups of toluene diisocyanate (“UA-4”) was obtained.

### Examples 1-3 and Comparative Examples 1-4

A reaction vessel equipped with a stirrer was charged with each component of the composition shown in Table 1. The mixture was stirred for one hour with stirring while controlling the liquid temperature at 50° C. to obtain a curable liquid resin composition. The amount of component shown in Table 1 is indicated in units of part by mass.

### Test Example

A specimen was prepared by curing each of the curable liquid resin compositions obtained in the examples and comparative examples according to a method described below, and was subjected to the following evaluation.

1. Young's Modulus

The curable liquid resin composition was applied to a glass plate using an applicator bar with a gap size of 250 □m, and was cured by applying ultraviolet rays at a dose of 1 J/cm² in air to obtain a Young's modulus measurement film. The film was cut into a specimen in the shape of a strip so that a portion to be drawn had a width of 6 mm and a length of 25 mm. The specimen was subjected to a tensile test at a temperature of 23° C. and a humidity of 50%. The Young's modulus was calculated from the tensile strength at a tensile rate of 1 mm/min and a strain of 2.5%.

2. Removal Properties

A resin-coated optical fiber with an outer diameter of 250 □m was prepared by applying a primary material (primary coating material) (“R1164” manufactured by JSR Corporation), a secondary material (secondary coating material) (“R3180” manufactured by JSR Corporation), and an ink material (“FS blue ink” manufactured by T & KTOKA) in that order to an upjacketed glass fiber (synthetic quartz rod manufactured by TSL) prepared using a rewinder model (manufactured by Yoshida Kogyo Ltd.), and curing the materials by applying ultraviolet rays. The resulting optical fiber was coated with an upjacket layer by applying each curable composition shown in Table 1 to the optical fiber using the above device and curing the composition by applying ultraviolet rays to prepare an upjacketed optical fiber with an outer diameter of 500 μm as a measurement specimen.

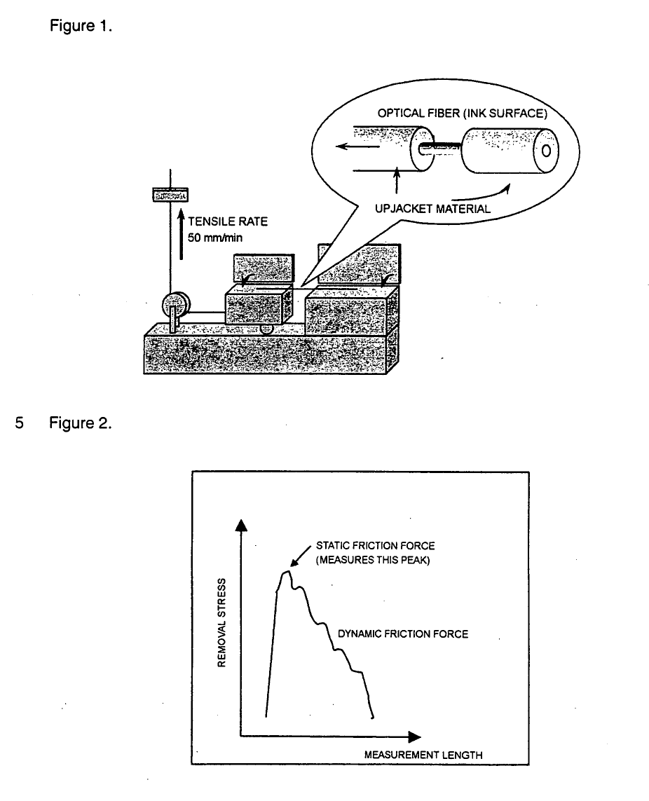

FIG. 1 shows a schematic diagram of a tensile tester, and FIG. 2 shows a stress behaviour schematic diagram when removing a coating. As shown in FIG. 1, the portion of the upjacketed optical fiber 3 cm from the end was held by using a hot stripper (manufactured by Furukawa Kogyo Co., Ltd.), and was pulled using a tensile tester (manufactured by Shimadzu Corporation) at a tensile rate of 50 m/min to measure the coating removal stress when removing the upjacket layer at a length of 3 cm (maximum stress shown in FIG. 2). The measurement was conducted immediately after the preparation of the upjacketed optical fiber.

The results are shown in Table 1.

TABLE 1

| | | Example | | | Comparative Example | | | |
|---|---|---|---|---|---|---|---|---|
| | | 1 | 2 | 3 | 1 | 2 | 3 | 4 |
| (A) | UA-1 | 37.65 | | | | | | |
| | UA-2 | | 7.29 | 7.29 | 7.68 | 7.68 | 7.29 | 7.29 |
| | UA-3 | | 60.65 | 60.65 | 63.93 | 63.93 | 60.65 | 60.65 |
| | UA-4 | | 4.96 | 4.96 | 5.22 | 5.22 | 4.96 | 4.96 |
| (B) | Tripropylene glycol diacrylate | 60.61 | | | | | | |
| | 2-Ethylhexyl acrylate | | 24.29 | 24.30 | 19.21 | 19.21 | 24.30 | 24.30 |
| (C) | Irgacure 184 | 1.45 | 2.42 | 2.43 | 3.60 | 3.60 | 2.43 | 2.43 |
| | Irgacure 819 | 0.29 | | | | | | |
| (D) | C302A | 148.13 | 72.90 | 36.45 | 0.00 | 0.00 | 0.00 | 0.00 |
| (E) | Tri(isopropylphenyl)phosphate | 20.27 | 17.02 | 17.01 | 12.00 | 6.03 | 17.02 | 0.00 |
| | Irganox1035 | | 0.38 | 0.37 | 0.35 | 0.36 | 0.37 | 0.37 |
| | Total amount of resin components | 100 | 100 | 100 | 100 | 100 | 100 | 100 |
| | Young's modulus (MPa) | 240 | 112 | 110 | 100 | 130 | 70 | 250 |
| | Coating removal stress (N) | 2.7 | 2.5 | 2.7 | 3.5 | 3.7 | 3.2 | 5.1 |

Irgacure 184: 1-hydroxycyclohexyl phenyl ketone (manufactured by Ciba Specialty Chemicals Co., Ltd.)
Irgacure 819: bis(2,4,6-trimethylbenzoyl)-phenylphosphine oxide (manufactured by Ciba Specialty Chemicals Co., Ltd.)
C302A; aluminum hydroxide particle with particle size of 2.0 μm (manufactured by Sumitomo Chemical Industries Co., Ltd.)
Irganox 1035: thiodiethylenebis[3-(3,5-di-tert-butyl-4-hydroxyphenyl)propionate](manufactured by Ciba Specialty Chemicals Co., Ltd.)

As is clear from Table 1, the upjacket material including particles with a particle size of 0.1-100 μm and the upjacket material further including a liquid flame retardant exhibited excellent properties as an optical fiber coating material and excellent removal properties. Therefore, these upjacket materials are useful as upjacket compositions.

1. A curable liquid resin composition for an optical fiber upjacket, the composition comprising: (A) a urethane (meth)acrylate, (B) a reactive diluent, (C) a polymerization initiator, and (D) particles with a number average particle size of 0.1-100 □m.

2. The curable liquid resin composition according to claim 1, wherein the particles (D) are one or more types of inorganic particles.

3. The curable liquid resin composition according to claim 1, further comprising (E), wherein (E) is not a compound corresponding to component (D).

4. The curable liquid resin composition according to claim 1, wherein the urethane (meth)acrylate (A) includes a reaction product of an aliphatic polyether polyol, a polyisocyanate, and a hydroxyl group-containing (meth)acrylate.

5. The curable liquid resin composition according to claim 4, wherein the urethane (meth)acrylate (A) includes a reaction product of a polyisocyanate and a hydroxyl group-containing (meth)acrylate compound in addition to the reaction product of an aliphatic polyether polyol, a polyisocyanate, and a hydroxyl group-containing (meth)acrylate.

6. The curable liquid resin composition according to claim 1, wherein the component (B) includes 2-ethylhexyl (meth)acrylate.

7. An optical fiber upjacket layer, comprising a cured product of the curable liquid resin composition according to claim 1.

8. An upjacketed optical fiber, comprising the optical fiber upjacket layer according to claim 7.
